(19) United States
(12) Patent Application Publication
(10) Pub. No.: US 2009/0161668 A1
(43) Pub. Date: Jun. 25, 2009

(54) DYNAMIC CLASSIFICATION OF INTERNET PROTOCOL PACKETS BASED ON MEASURED CHARACTERISTICS AND INTERNET PROTOCOL ADDRESS PREFIX

(76) Inventors: John Joseph Mullooly, Colts Neck, NJ (US); Aamer Saeed Akhter, Cary, NC (US); Dana L. Blair, Alpharetta, GA (US); David John Smith, Scotch Plains, NJ (US)

Correspondence Address: SCHWEGMAN, LUNDBERG & WOESSNER, P.A., P.O. BOX 2938, MINNEAPOLIS, MN, 55402, US

(21) Appl. No.: 11/961,728

(22) Filed: Dec. 20, 2007

(51) Int. Cl. H04L 12/56

(52) U.S. Cl. 370/389

(57) ABSTRACT

In an example embodiment, a method is provided where a characteristic of a flow of Internet Protocol (IP) packet is measured. Here, the flow is associated with an IP address prefix. Further, an attribute of a routing protocol is associated with the IP address prefix based on the characteristic. An advertisement then is transmitted by way of a routing protocol. The advertisement includes the attribute and the IP address prefix associated with the attribute. Another method is provided where the advertisement is received. Here, the IP address prefix is associated with a class of service that is associated with the attribute. An IP packet associated with the IP address prefix is received and this IP packet is classified to a class of service based on the IP address prefix. The IP packet then is marked with a value that is associated with the class of service.

### FIELD

The present disclosure relates generally to computer networks. In an example embodiment, the disclosure relates to the dynamic classification of Internet Protocol (IP) packets based on measured characteristics and IP address prefix.

### BACKGROUND

Data packets in an Internet Protocol (IP) differentiated services model may be classified at ingress to a computer network to the appropriate class of service. However, classification must be manually configured at the upstream ingress points. For a large enterprise wide area network with hundreds of sites, the classification of router configurations needs to be performed at all edge locations, which can be operationally intensive.

### BRIEF DESCRIPTION OF DRAWINGS

The present disclosure is illustrated by way of example and not limitation in the figures of the accompanying drawings, in which like references indicate similar elements and in which:

FIG. 1 is a diagram of a networked system, in accordance with an example embodiment;

FIGS. 2a and 2b are simplified diagrams of an example computer network, in accordance with example embodiments;

FIG. 3 is a simplified block diagram of modules included in an apparatus, in accordance with an example embodiment;

FIG. 4 is a flow diagram of a general overview of a method, in accordance with an example embodiment, for dynamically classifying Internet Protocol (IP) address prefixes based on measured characteristics;

FIG. 5 is a simplified diagram of an enterprise network, in accordance with an example embodiment, that transmits attributes through advertisements by way of a routing protocol;

FIG. 6 is a flow diagram of a general overview of a method, in accordance with an example embodiment, for associating an IP address prefix with a class of service;

FIG. 7 is a flow diagram of a general overview of a method, in accordance with an example embodiment, for classifying an IP packet to a class of service;

FIG. 8 is a simplified diagram of an enterprise network, in accordance with an example embodiment, that classifies IP packets; and

FIG. 9 is a simplified block diagram of a machine in the example form of a computing system.

### DESCRIPTION OF EXAMPLE EMBODIMENTS

In the following description, for purposes of explanation, numerous specific details are set forth in order to provide a thorough understanding of an example embodiment of the present disclosure. It will be evident, however, to one skilled in the art that the present disclosure may be practiced without these specific details.

Overview

An example method is provided where a characteristic of a flow of Internet Protocol (IP) packets is measured. Here, the flow is associated with an IP address prefix. As explained in more detail below, an attribute of a routing protocol may be associated with the IP address prefix based on the characteristic. An advertisement may then be transmitted by way of the routing protocol. The advertisement may include the attribute and the IP address prefix associated with the attribute.

Another example method is provided where an advertisement is received. The advertisement may include an attribute of a routing protocol and an IP address prefix associated with the attribute. The IP address prefix may be associated with a class of service and the class of service is associated with the attribute. An IP packet associated with the IP address prefix may be received and the IP packet is classified to the class of service based on the IP address prefix. The IP packet may then be marked with a value that is associated with the class of service.

### Example Embodiments

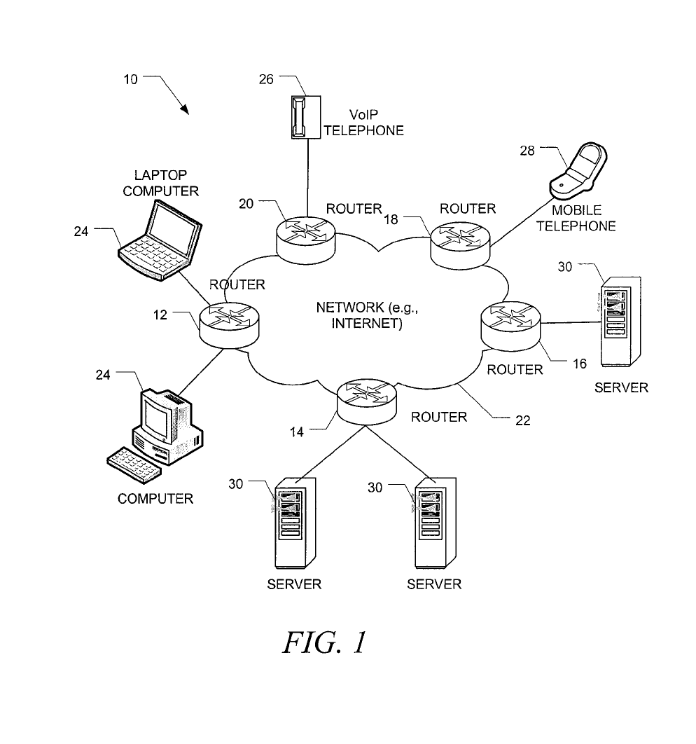

FIG. 1 is a diagram of a networked system, in accordance with an example embodiment. Example system 10 includes various network endpoints (e.g., network nodes) and network devices, and data is communicated between the various network endpoints and network devices. In the example system 10, network endpoints may include routers 12, 14, 16, 18 and 20. However, it will be appreciated that any number of routers 12-20 may be provided in system 10. Routers 12-20 are shown to be connected via a network which may include one or more Local Area Networks (LANs) and/or Wide Area Networks (WANs), such as the Internet. System 10 also includes network devices including, for example, computers 24, Voice-over-IP (VoIP) telephone 26, mobile telephone 28, and servers 30.

In the example system 10, data is communicated by way of Internet Protocol (IP) packets or datagrams using a variety of suitable upper-layer transport communication protocols. For example, packets may be encapsulated and communicated using the Transmission Control Protocol (TCP)/Hypertext Transport Protocol (HTTP), the User Datagram Protocol (UDP) protocol, and/or the SCTP. Further, although system 10 is shown to include routers 12-20, it should be noted that the example embodiments described herein are equally applicable to other network devices, such as switches or the like. Broadly, the example embodiments described herein may be deployed in a variety of network devices that receive digital data for processing and communication to other network devices.

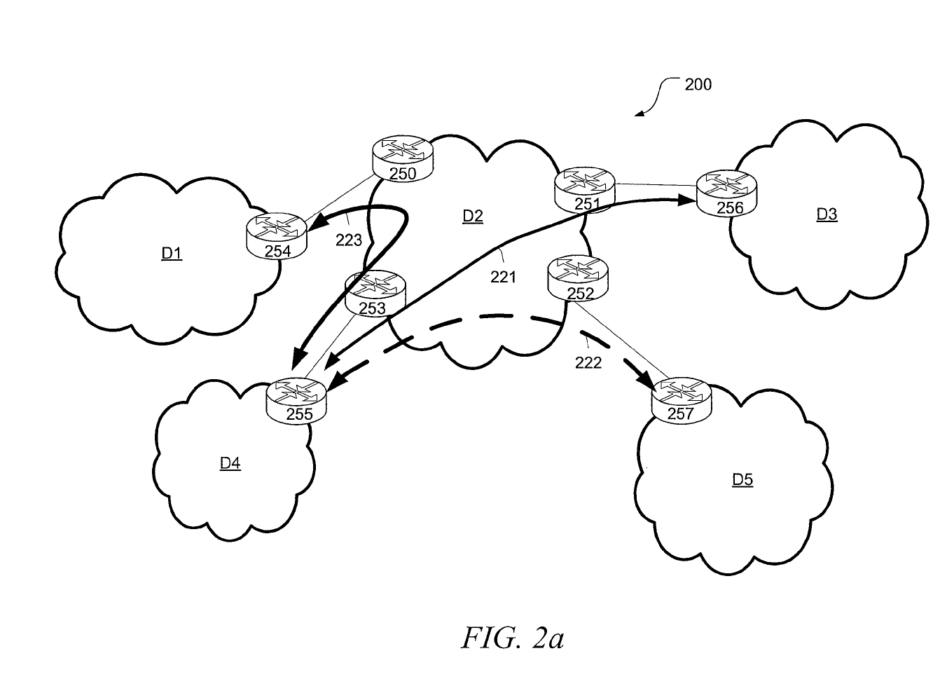

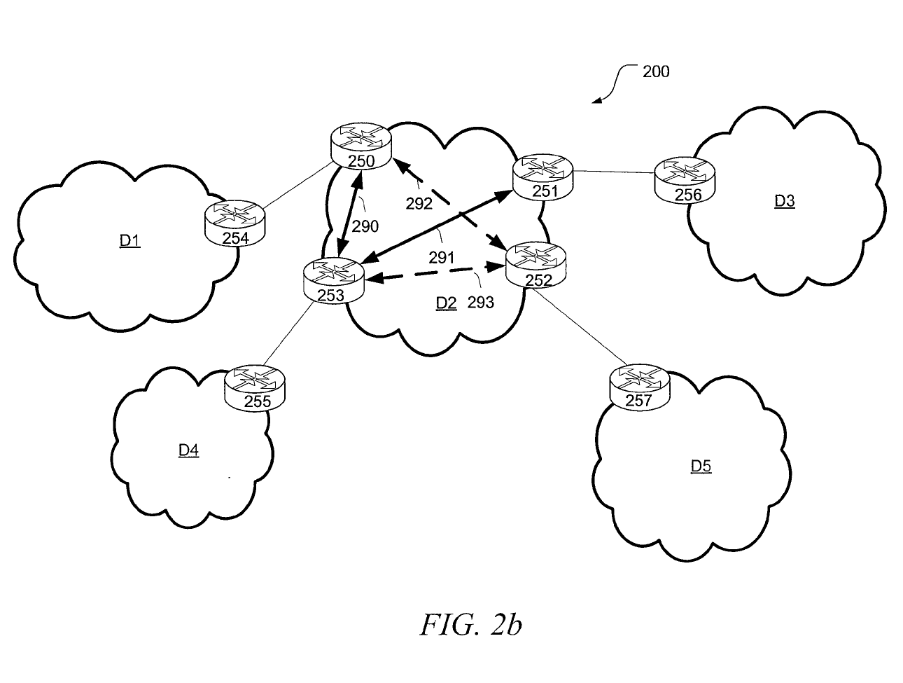

FIGS. 2a and 2b are simplified diagrams of an example computer network, in accordance with example embodiments. As shown in FIG. 2a, computer network 200 includes multiple domains D1-D5 interconnected by routers 250-257. It should be appreciated that groups of computer networks may be maintained as routing domains D1-D5. A domain, such as domain D1, D2, D3, D4 or D5, is a collection of nodes (e.g., routers) under the control of one or more entities that present a common routing policy. Domain D1, D2, D3, D4 or D5 may also be referred to as an autonomous system or community. The distinct networks within domains D1-D5 can be coupled together by inter-domain routers 250-257 that are configured to communicate by way of routing protocols and are generally subject to a common authority. A provider edge (PE) router is an example of an inter-domain router. The provider edge router is placed at the edge of an Internet service provider (ISP) network, and may communicate by way of a routing protocol to another provider edge router or domain. The routers 250-253 are examples of PE routers. A customer edge (CE) router is another example of an inter-domain router. The customer edge router is located at the edge of a network associated with a customer or subscriber, and the customer edge router may communicate by way of a routing protocol to other routers internal or external to its domain. As shown in FIG. 2a, routers 254-257 are examples of CE routers.

In the example computer network 200 of FIG. 2a, routers 250-257 communicate by way of routing protocols. In general, a routing protocol is a protocol that specifies how routers communicate with each other to disseminate IP address prefixes and thereby allows the routers to select routes for flows of IP packets. An example of a routing protocol is the Border Gateway Protocol (BGP), which is an inter-domain routing protocol used within the Internet to exchange IP address prefix and network layer reachability information between domains and to distribute external IP address prefix information within a domain. Other examples of routing protocols include Open Shortest Path First (OSPF) protocol, Enhanced Interior Gateway Routing Protocol (EIGRP), and other routing protocols. It should be appreciated that routers 250-257 may be configured to classify IP packets into different classes of services. A class of service may define the priority level assigned to one or more IP packets. Examples of classes of services include expedited forwarding (EF), assured forwarding gold (AF21), assured forwarding silver (AF11), best effort (BE), and other classes of services.

In an illustrative example, FIG. 2a shows that IP packets may traverse along routes 221-223. The IP packets transmitted along routes 221 and 223, which are illustrated by solid lines, are classified as expedited forwarding. On the other hand, the IP packets transmitted along route 222, which is illustrated as a dotted line, is classified as best effort. Expedited forwarding has a higher priority level than best effort. Accordingly, given limited network bandwidth, for example, routers 250-257 that receive IP packets associated with routes 221-223 will give higher priority to IP packets associated with routes 221 and 223. Routers 250-257 may therefore, for example, limit the rate of flow of IP packets associated with route 222 or enqueue (delay) such IP packets until the IP packets associated with routes 221 and 223 have been transmitted.

It should be noted that routers 250-257 may classify an IP packet based on its source and/or destination IP address. An IP address is a unique address used by routers (or other networked devices) for communication on computer network 200 that uses the IP standard. In an example, as explained in more detail below, IP packet classification may be based on the associated (or matching) IP address prefix within, for example, a routing table. The IP address prefix can represent a range of IP addresses. Alternatively, the IP address prefix can represent a single IP address. As shown in FIG. 2b, router 250, 251, 252 or 253 may receive an IP packet. Upon receiving the IP packet, router 250, 251, 252 or 253 may classify the IP packet to a class of service based on the IP address prefix associated with the IP source or destination address of the IP packet. Here, IP packets transmitted to and/or received from specific IP addresses can be prioritized above or below other IP packets. Classes of services may include, for example, expedited forwarding or best effort. After the IP packet is classified using the matching IP address prefix within a routing table, router 250, 251, 252 or 253 marks (or tags) the IP packet based on the associated class of service. As explained in more detail below, for example, the IP packet may be marked with a Differentiated Services Code Point (DSCP) value that is associated with the class of service. The IP packet is transmitted between routers 250-257 based on the class of service. For example, as shown in FIG. 2b, IP packets transmitted between routers 250 and 252, and between routers 252 and 253 may be classified as best effort (as illustrated with a dotted line). In contrast, IP packets transmitted between routers 251 and 253, and between 250 and 253 may be classified as expedited forwarding (as illustrated with a solid line).

It should be noted that a number of nodes, routers, links, etc. may be used in computer network 200, and that the computer network of FIGS. 2a and 2b shown herein is for simplicity. Further, computer network 200 is described in relation to multiple domains D1-D5, and the computer network may apply to a variety of other inter-domain network configurations, such as IP virtual private networks (VPNs), inter-autonomous system VPNs, and other network configurations.

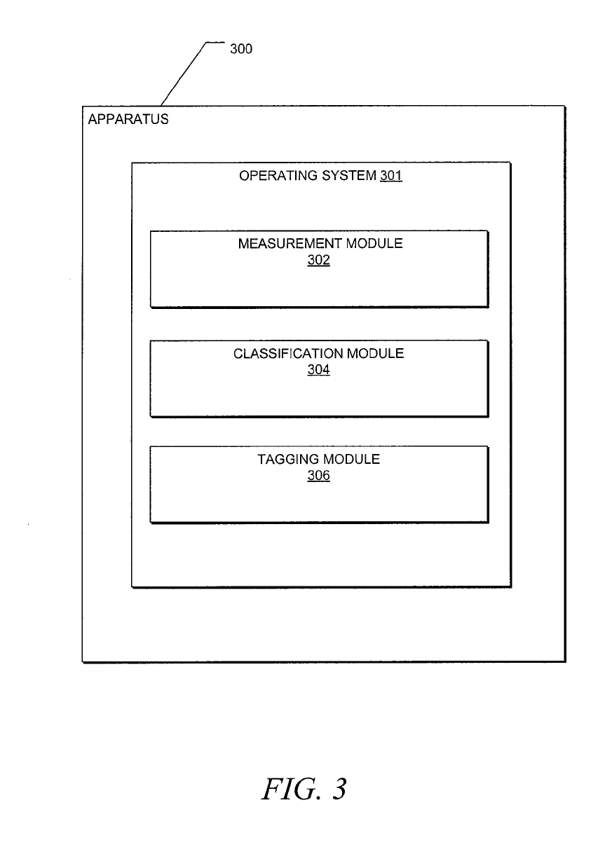

FIG. 3 is a simplified block diagram of modules included in an apparatus, in accordance with an example embodiment. Apparatus 300 includes operating system 301 (e.g., an Internetworking Operating System) that manages the software processes and/or services executing on the apparatus. As shown in FIG. 3, these software processes and/or services may include measurement module 302, classification module 304, and tagging module 306. It should be appreciated that apparatus 300 may be deployed in the form of a variety of network devices that receive data for communication to other network devices, such as routers or the like. For example, apparatus 300 may form a part of one of the network devices depicted in FIGS. 2a and 2b, such as routers 250-257. In various example embodiments, apparatus 300 may be used to implement computer programs, logic, applications, methods, processes, or other software to measure a characteristic of a flow of IP packets and to associate an attribute of the routing protocol to an IP address prefix based on the characteristic, as described in more detail below.

Referring to FIG. 3, measurement module 302 can automate routing of IP packets to select routes based on characteristics or factors such as load distribution policy and overall network performance. An example of measurement module 302 is an optimized edge routing (OER) module. Measurement module 302 is configured to measure one or more characteristics of a flow of IP packets (or network traffic). Examples of characteristics that may be measured include latency, packet loss, jitter, mean opinion score (MOS), path availability, traffic load distribution, and other characteristics. As described in more detail below, after the characteristic is measured, measurement module 302 may associate an attribute of a routing protocol with an IP address prefix based on the measured characteristic.

Classification module 304, on the other hand, is configured to classify IP packets by IP precedence or DSCP based on, for example, BGP community lists, BGP autonomous system paths, and access control lists (ACLs). An example of classification module 304 includes a Quality of Service Policy Propagation through BGP (QPPB) module. In addition, as explained in more detail below, classification module 304 may classify received IP packets to one or more classes of services.

Additionally included in apparatus 300 is tagging module 306 that, as explained in more detail below, is configured to mark (or tag) an IP packet with a value that is associated with the class of service, as classified by classification module 304. It should be appreciated that in other example embodiments, apparatus 300 may include fewer or more modules apart from those shown in FIG. 3. For example, classification module 304 may be integrated together with tagging module 306 to form one module.

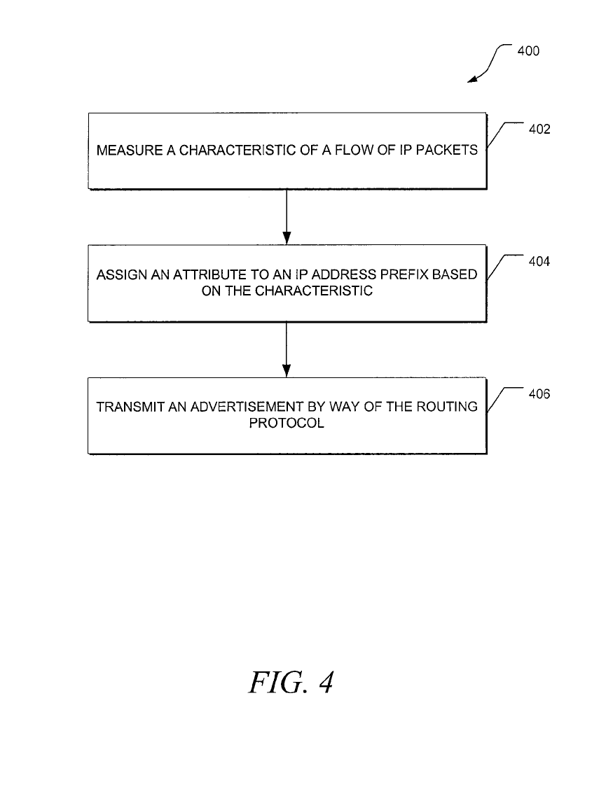

FIG. 4 is a flow diagram of a general overview of a method, in accordance with an example embodiment, for dynamically classifying IP address prefixes based on measured characteristics. In an example embodiment, method 400 may be implemented by measurement module 302 of FIG. 3, employed in an apparatus, such as routers 250-257 of FIGS. 2a and 2b. As shown in FIG. 4, in an example embodiment, one or more characteristics of a flow of IP packets (or network traffic) are measured at 402. The flow of IP packets is associated with a particular IP address prefix. Here, the IP packets included in the flow are associated with a particular IP address prefix. For example, the IP packets may all have a matching IP address prefix of a 10.0.0.0/8 value.

Thereafter, at 404, an attribute of a routing protocol is associated with the IP address prefix based on the characteristic. An attribute is a property associated with a routing protocol. With Border Gateway Protocol, for example, attributes may include local preference, multi-exit discriminator, origin, next hop, community, and other attributes. In an example embodiment, the attribute is the community attribute. In general, the community attribute can be a four byte value that enables IP address prefixes to be grouped into domains (or communities). As illustrated in more detail below, the association may include, for example, a particular attribute to be associated with a particular threshold of a characteristic.

After the attribute is associated with the IP address prefix, an advertisement is transmitted at 406 by way of the routing protocol. An advertisement is a message associated with the routing protocol. Here, the advertisement includes the attribute and the IP address prefix associated with the attribute. The advertisement may be transmitted to other routers within a domain or to routers located in other domains.

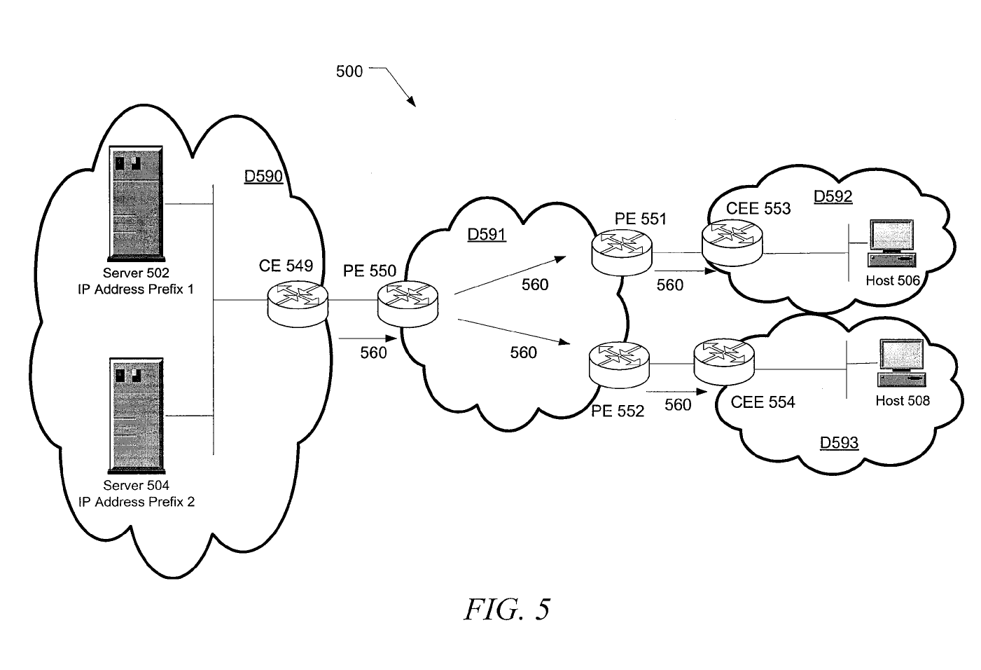

FIG. 5 is a simplified diagram of an enterprise network, in accordance with an example embodiment, that transmits attributes through advertisements by way of a routing protocol. Enterprise network 500 includes servers 502 and 504, provider edge (PE) routers 550-552, customer edge (CE) routers 549, 553, and 554 and hosts 506 and 508 that are organized into multiple domains D590-D593. As shown in FIG. 5, domain D590 includes servers 502 and 504 and CE router 549. An example of domain D590 is the headquarter site of an enterprise. The domain D591 includes PE routers 550-552 and this domain, for example, may be a service router domain. Additionally, host 506 and CE router 553 are included in domain D592. Similarly, host 508 and CE router 554 are included in domain D593. Domains 592 and 593 may be enterprise remote sites. It should be noted that enterprise network 500 is connected to a Layer 3 VPN wide area network (WAN) service, which is based on Multiprotocol Label Switching (MPLS), that is provided by a service provider.

Here, CE router 549 is advertising IP address prefix value of 1 and IP address prefix value of 2 associated with server 502 and server 504, respectively. The customer has built enterprise network 500 such that server 502 having IP address prefix value of 1 is executing business applications. Server 504 having IP address prefix value of 2 is executing other non-business applications. CE router 549 is actively and/or passively measuring one or more characteristics of flows of IP packets having IP address prefixes of 1 and 2 values to and from the CE router. In the example of FIG. 5, the characteristic that is measured is latency. In brief, latency is the transit time of data over one or more routes. The latency, for example, can also be stated as the time delta between the transmission and receipt of data (e.g., IP packets) between two hosts.

In this example, the customer has specified that if latency is less than 100 ms, then IP packets destined to server 502, which is associated with IP address prefix of 1 value, are to be classified as assured forwarding gold. On the other hand, if the latency exceeds 100 ms, then IP packets destined to the same server 502 are to be classified as assured forwarding silver, which has a lower priority than assured forwarding gold. Here, a community 1 attribute is associated with assured forwarding gold. A community 2 attribute is associated with assured forwarding silver. If CE router 549 measures the latency to be less than 100 ms, then the CE router associates the community 1 attribute with the IP address prefix value of 1. On the other hand, if CE router 549 measures the latency to exceed 100 ms, then the CE router associates the community 2 attribute with the IP address prefix value of 2.

CE router 549 may then transmit advertisement 560 with the attribute and the associated IP address prefix to other routers 550-554 by way of Border Gateway Protocol. Advertisement 560 may include community 1 attribute and IP address prefix value of 1. Depending on the latency measured, advertisement 560 may instead include community 2 attribute. It should be appreciated that in addition to CE router 549, the other routers 550-554 in enterprise network 500 may also be configured to measure the latency, to associate the community attribute with an IP address prefix, and to transmit advertisement 560.

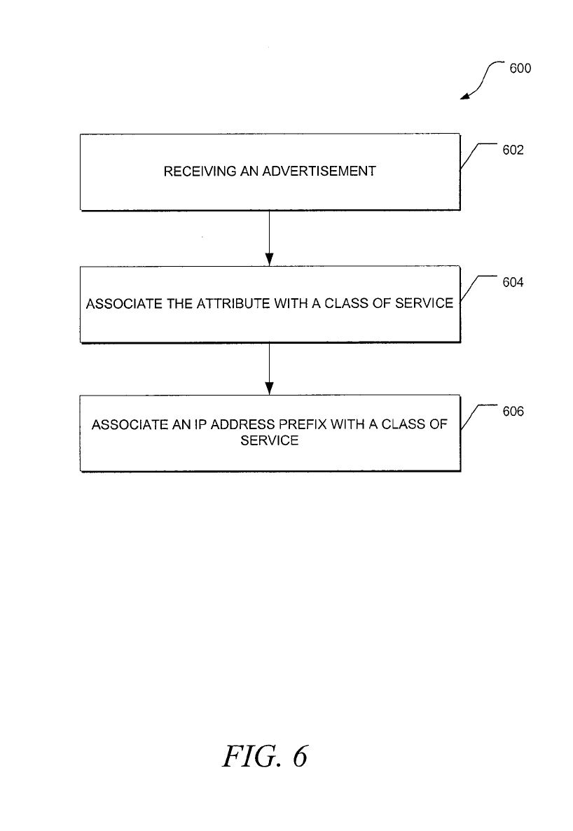

FIG. 6 is a flow diagram of a general overview of a method, in accordance with an example embodiment, for associating an IP address prefix with a class of service. In an example embodiment, method 600 may be implemented by classification module 304 of FIG. 3, employed in an apparatus, such as routers 250-257 of FIGS. 2a and 2b. As shown in FIG. 6, an advertisement is received at 602. The advertisement includes an attribute of a routing protocol and an IP address prefix that is associated with the attribute.

After the advertisement is received, in an example embodiment, the attribute may be associated with a class of service at 604. The association of the attribute with the class of service may be programmed into the classification module or may be stored in a variety of data structures, such as arrays, tables, and other data structures. The following mapping is an example of associations of attributes with various classes of services:

TABLE A

| Attribute | Class of Service |
|---|---|
| Community 1 | Expedited Forwarding |
| Community 2 | Assured Forwarding Gold |
| Community 3 | Assured Forwarding Silver |
| Community 4 | Best Effort |

The above Table A is organized in rows and columns. Elements associated with the column “attribute” include various community attributes. Elements associated with the column “class of service” include various classes of services that are associated with the various community attributes. In Table A, there is a one-to-one correspondence between an attribute element and a class of service element. For example, community 1 attribute is associated with expedited forwarding. Similarly, community 2 attribute is associated with assured forwarding gold. In an example embodiment, to associate an attribute with a class of service, the received attribute is identified (e.g., community 4) and the class of service associated with the attribute (e.g., best effort) then is located.

Thereafter, the IP address prefix is associated with a class of service at 606. In an example embodiment, the IP address prefixes and the associated classes of services are stored in a routing table. In brief, a routing table is stored in an apparatus (e.g., a router) and stores a variety of information associated with a computer network, such as topology and other information. In an example embodiment, the association may include identifying the matching IP address prefix in the routing table. An existing class of service associated with the IP address prefix then is located within the routing table. It should be noted that this existing class of service associated with the IP address prefix already is stored in the routing table. With the existing class of service located, this existing class of service stored in the routing table then is replaced with the class of service from 604, as discussed above. As a result, the advertisements provide updates of classes of services associated with IP address prefixes to reflect the dynamic changes in network characteristics.

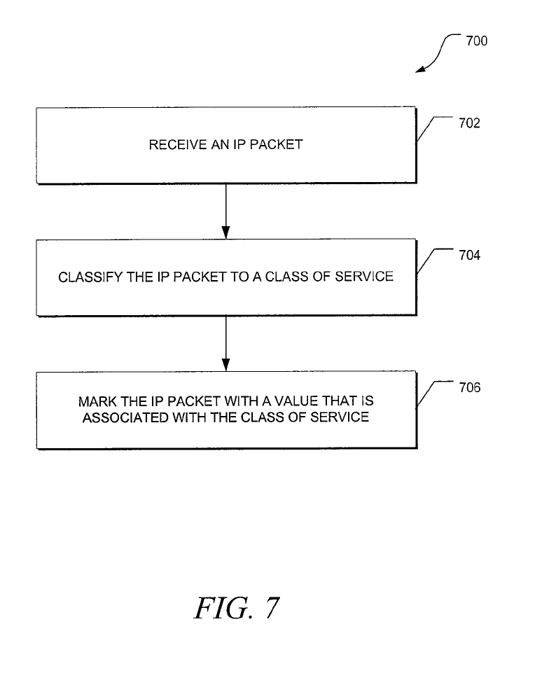

FIG. 7 is a flow diagram of a general overview of a method, in accordance with an example embodiment, for classifying an IP packet to a class of service. In an example embodiment, method 700 may be implemented by classification module 304 of FIG. 3, employed in an apparatus, such as routers 250-257 of FIGS. 2a and 2b. As shown in FIG. 7, one or more IP packets are received at 702. The IP source and/or destination address associated with an IP packet is read and, at 704, the IP packet then is classified to a class of service based on the IP address prefix associated with the IP packet (or flow of the IP packet). In an example embodiment, the routing table stores the IP address prefixes and the classes of services that are associated with the IP address prefixes. The IP address prefix of the received IP packet is identified in the routing table. Thereafter, the class of service associated with the IP address prefix is located in the routing table. The IP packet received is associated with this class of service located from the routing table.

After the received IP packet is associated with a class of service, the IP packet is marked (or tagged) at 706 with a value that is associated with the class of service. For example, the IP packet is marked with a value that corresponds to the above-identified class of service. The value is information associated with the IP packet. For example, the value may include an MPLS experimental (EXP) bit value (or EXP field) associated with an IP packet. The EXP bit value can be a three-bit value in the MPLS shim header. The EXP bit value may be used to define Quality of Service treatment and/or to encode dropping precedence. In another example, the value may include a DSCP value. The DSCP generally defines a class and may also define a drop precedence within a class. In still another example, the value may be an IP precedence value, which may be the first three bits of the Type of Service field.

It should be noted that, in an example embodiment, the class of service is further associated with a value. The association may be derived from a mapping of the classes of services and of values that are associated with the classes of services. Here, the routing table can also store the value that is associated with the class of service. The value therefore corresponds to the class of service, and the IP packet is marked and handled according to its marked class of service.

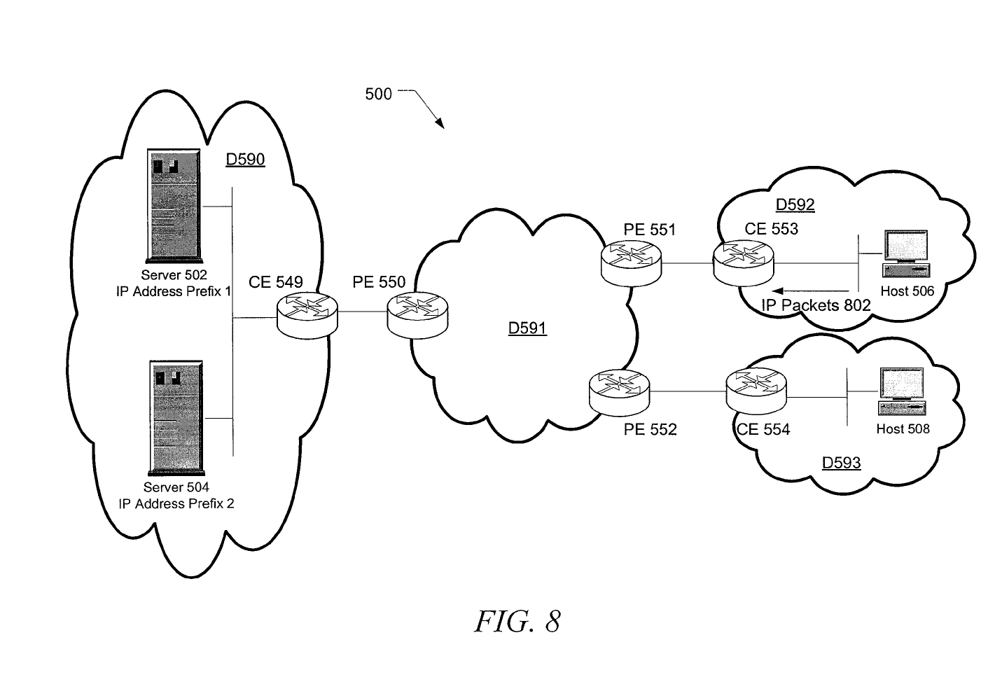

FIG. 8 is a simplified diagram of an enterprise network, in accordance with an example embodiment, that classifies IP packets. As discussed above in FIG. 5, enterprise network 500 includes servers 502 and 504, provider edge (PE) routers 550-552, customer edge (CE) routers 549, 553, and 554 and hosts 506 and 508 that are organized into multiple domains D590-D593.

Referring to FIG. 8, CE router 553 receives an advertisement transmitted by CE router 549. The advertisement includes an attribute and an IP address prefix associated with the attribute. In the example of FIG. 8, the advertisement includes a community 1 attribute and an IP address prefix value of 1, which is associated with server 502. The community 1 attribute then is associated with a class of service based on a mapping of the association of the attribute with the class of service. In this example, community 1 maps to expedited forwarding. Accordingly, the community 1 attribute is associated with expedited forwarding. IP address prefix value of 1 then is associated with expedited forwarding. Here, the routing table of CE 553 stores the IP address prefixes and the associated classes of services. Within the routing table, the existing class of service that is associated with IP address prefix value of 1 is defined as best effort. In view of the advertisement received, the routing table is updated such that expedited forwarding is associated with IP address prefix value of 1.

After the routing table is updated, CE 553 receives IP packets 802 from host 506. Depending on the IP address prefix, IP packets 802 may be addressed to server 502 associated with IP address prefix value of 1 or addressed to server 504 associated with IP address prefix value of 2. In the example shown in FIG. 8, CE 553 receives an IP packet, which is one of many IP packets 802, with an IP address prefix value of 1. CE 553 then classifies this IP packet to a class of service based on the IP address prefix value of 1. The classification may include identifying the IP address prefix value of 1 within the routing table of CE 553, and locating the class of service (expedited forwarding) associated with the IP address prefix. The IP packet may therefore be associated with expedited forwarding based on the IP address prefix value of 1.

After classification, the IP packet is marked with a DSCP value that is associated with expedited forwarding. For example, the DSCP value may be inserted into the six bits of a differentiated services field. As a result, the IP packet is marked for expedited forwarding treatment by CE 553 and by many or all downstream routers 549-552. It should be appreciated that classification of IP packets 802 depends on the updates provided by the advertisements. The advertisements reflect the dynamic changes in network characteristics. Therefore, the classification of IP packets also is dynamic. In addition to CE router 553, it should be noted that other routers 549-552 and 554 in enterprise network 500 may also be configured to classify and mark received IP packets, such as IP packets 802.

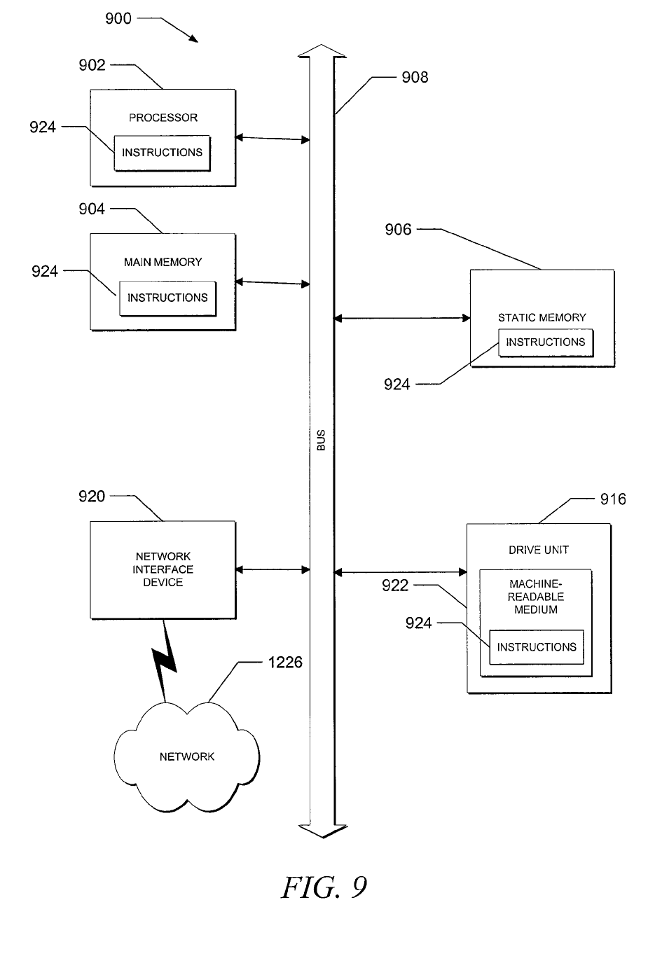

FIG. 9 is a simplified block diagram of a machine in the example form of a computing system within which a set of instructions, for causing the machine to perform any one or more of the methodologies discussed herein, may be executed. In alternative embodiments, the machine may be connected (e.g., networked) to other machines. The machine may be a network router (e.g., label switch router), switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computing system 900 includes processor 902 (e.g., a central processing unit (CPU)), main memory 904 and static memory 906, which communicate with each other via bus 908. Computing system 900 may also include disk drive unit 916 and network interface device 920.

Disk drive unit 916 includes machine-readable medium 922 on which is stored one or more sets of instructions and data structures (e.g., software 924) embodying or utilized by any one or more of the methodologies or functions described herein. Software 924 may also reside, completely or at least partially, within main memory 904 and/or within processor 902 during execution thereof by computing system 900, with main memory 904 and processor 902 also constituting machine-readable, tangible media. Software 924 may further be transmitted or received over network 926 via network interface device 920 utilizing any one of a number of well-known transfer protocols (e.g., Trivial File Transfer Protocol (TFTP)).

While machine-readable medium 922 is shown in an example embodiment to be a single medium, the term “machine-readable medium” should be taken to include a single medium or multiple media (e.g., a centralized or distributed database, and/or associated caches) that store the one or more sets of instructions. The term “machine-readable medium” shall also be taken to include any medium that is capable of storing, encoding or carrying a set of instructions for execution by the machine and that cause the machine to perform any one or more of the methodologies of the present application, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method comprising:
measuring a characteristic of a flow of a first Internet Protocol (IP) packet, the flow being associated with an IP address prefix;
associating an attribute of a routing protocol with the IP address prefix based on the characteristic; and
transmitting an advertisement by way of the routing protocol, the advertisement including the attribute and the IP address prefix associated with the attribute.

2. The method of claim 1, further comprising:
receiving the advertisement;
associating the IP address prefix with a class of service, the class of service being associated with the attribute;
receiving a second IP packet associated with the IP address prefix;
classifying the second IP packet to the class of service based on the IP address prefix associated with the second IP packet; and
marking the second IP packet with a Differentiated Services Code Point (DSCP) value, the DSCP value being associated with the class of service.

3. The method of claim 1, wherein the attribute is a community attribute.

4. The method of claim 1, wherein the routing protocol is a Border Gateway Protocol.

5. A method comprising:
receiving an advertisement that includes an attribute of a routing protocol and an Internet Protocol (IP) address prefix associated with the attribute;
associating the IP address prefix with a class of service, the class of service being associated with the attribute;
receiving an IP packet associated with the IP address prefix;
classifying the IP packet to the class of service based on the IP address prefix associated with the IP packet; and
marking the IP packet with a value, the value being associated with the class of service.

6. The method of claim 5, wherein the value is at least one of a Multiprotocol Label Switching experimental bit value, a Differentiated Services Code Point (DSCP) value or an Internet Protocol precedence value.

7. The method of claim 5, further comprising associating the attribute with the class of service.

8. The method of claim 5, further comprising associating the class of service with the value.

9. The method of claim 5, wherein the classifying the IP packet to the class of service comprises:
identifying the IP address prefix stored in a routing table, the routing table comprising a plurality of IP address prefixes and a plurality of classes of services;
locating the class of service stored in the routing table, the class of service being associated with the IP address prefix; and
associating the IP packet with the class of service.

10. The method of claim 5, wherein the associating the IP address prefix comprises:
identifying the IP address prefix stored in a routing table, the routing table comprising a plurality of IP address prefixes and a plurality of classes of services; and
locating an existing class of service stored in the routing table, the existing class of service being associated with the IP address prefix; and
replacing the existing class of service with the class of service in the routing table.

11. An apparatus comprising:
a processor; and
a memory in communication with the processor, the memory comprising instructions executable by the processor, when the instructions are executed the processor being operable to:
measure a characteristic of a flow of a first Internet Protocol (IP) packet, the flow being associated with an IP address prefix;
associate an attribute of a routing protocol with the IP address prefix based on the characteristic; and
transmit an advertisement by way of the routing protocol, the advertisement including the attribute and the IP address prefix associated with the attribute.

12. The apparatus of claim 11, wherein the processor is further operable to:
receive the advertisement;
associate the IP address prefix with a class of service, the class of service being associated with the attribute;
receive a second IP packet associated with the IP address prefix;
classify the second IP packet to the class of service based on the IP address prefix associated with the second IP packet; and
mark the second IP packet with a Differentiated Services Code Point (DSCP) value, the DSCP value being associated with the class of service.

13. The apparatus of claim 11, wherein the characteristic is latency.

14. The apparatus of claim 11, wherein the characteristic is jitter.

15. An apparatus comprising:
a processor; and
a memory in communication with the processor, the memory comprising instructions executable by the processor, when the instructions are executed the processor being operable to:
receive an advertisement that includes an attribute of a routing protocol and an Internet Protocol (IP) address prefix associated with the attribute;
associate the IP address prefix with a class of service, the class of service being associated with the attribute;
receive an IP packet associated with the IP address prefix;
classify the IP packet to the class of service based on the IP address prefix associated with the IP packet; and
mark the IP packet with a value, the value being associated with the class of service.

16. The apparatus of claim 15, wherein the processor is further operable to associate the attribute with the class of service.

17. The apparatus of claim 15, wherein the processor is further operable to associate the class of service with the value.

18. The apparatus of claim 15, wherein the processor is further operable to:
identify the IP address prefix stored in a routing table, the routing table comprising a plurality of IP address prefixes and a plurality of classes of services;
locate the class of service stored in the routing table, the class of service being associated with the IP address prefix; and
associate the IP packet with the class of service.

19. The apparatus of claim 15, wherein the processor is further operable to:
identify the IP address prefix stored in a routing table, the routing table comprising a plurality of IP address prefixes and a plurality of classes of services; and
locate an existing class of service stored in the routing table, the existing class of service being associated with the IP address prefix; and
replace the existing class of service with the class of service in the routing table.

20. An apparatus comprising:
a measurement module for measuring a characteristic of a flow of a first Internet Protocol (IP) packet, the flow being associated with an IP address prefix;
a means for associating an attribute of a routing protocol with the IP address prefix based on the characteristic; and
an operating system for transmitting an advertisement by way of the routing protocol, the advertisement including the attribute and the IP address prefix associated with the attribute.
